(19) United States
(12) Patent Application Publication
(10) Pub. No.: US 2012/0307526 A1
(43) Pub. Date: Dec. 6, 2012

(54) DC-DC CONVERTER DEVICE

(75) Inventor: Thilak SENANAYAKE, Nagoya-city (JP)

(73) Assignee: DENSO CORPORATION, Kariya-city (JP)

(21) Appl. No.: 13/473,798

(22) Filed: May 17, 2012

(30) Foreign Application Priority Data
Jun. 3, 2011 (JP) 2011-125522

(51) Int. Cl. H02M 3/335; G05F 3/08

(52) U.S. Cl. 363/16; 323/311

(57) ABSTRACT

A DC-DC converter circuit steps down a power source voltage and supplies a stepped-down DC power. The DC-DC converter circuit includes a voltage divider circuit formed of plural capacitive elements for dividing the power source voltage. The DC-DC converter circuit includes plural current supply circuits provided between the voltage divider circuit and output terminals. The current supply circuits connect each of the capacitive elements to the output terminals such that each of the capacitive elements supplies the power to the output terminals in the same polarity. The current supply circuits include plural switching elements, which selectively render the current supply circuits conductive.

### CROSS REFERENCE TO RELATED APPLICATION

This application is based on and incorporates herein by reference Japanese patent application No. 2011-125522 filed on Jun. 3, 2011.

### TECHNICAL FIELD

The present disclosure relates to a DC-DC converter device, which outputs a DC power after stepping down an input voltage.

### BACKGROUND

Conventional DC-DC converters are disclosed exemplarily in the following patent documents.

[Patent document 1] JP H07-241071A

[Patent document 2] JP 2010-148227A

[Patent document 3] JP H06-269171A

A DC-DC converter device according to patent document 1 supplies an output current by interrupting a current supplied from a power source by switching elements and smoothing by a reactor. In case that an input voltage from the power source and an output voltage to a load differ largely, the switching elements need be selected to withstand the high voltage of the power source. This DC-DC converter device thus needs the switching elements, which can withstand the high voltage of the power source when the difference between the voltage of the power source and the voltage of the load is large.

A DC-DC converter device according to patent document 2 includes a capacitive divider circuit connected in parallel to a power source. This DC-DC converter device supplies a current to a transformer, which is a load, from a junction between two capacitors. A voltage divided by the capacitive divider circuit is supplied to the transformer as an AC voltage. This DC-DC converter device cannot supply the voltage divided by the capacitive divider circuit to the load as a DC voltage.

A DC-DC converter device according to patent document 3 includes a capacitive divider circuit connected in parallel to a power source. This DC-DC converter device supplies two voltages divided by the capacitive divider circuit to two transformers. This DC-DC converter device cannot supply the voltages divided by the capacitive divider circuit to a common load.

### SUMMARY

It is an object to provide a DC-DC converter device, which is capable of supplying a DC voltage to a load by efficiently stepping down a high voltage of a DC power source.

It is another object to provide a DC-DC converter device, which suppresses loss in switching elements.

A DC-DC converter device is provided for stepping down a DC power supplied to input terminals and supplying a stepped-down DC power to output terminals. The DC-DC converter device comprises a voltage divider circuit, plural current supply circuits and a control circuit. The voltage divider circuit is connected between the input terminals in series and includes plural capacitive elements for dividing an input voltage supplied to the input terminals. The plural current supply circuits are provided between the voltage divider circuit and the output terminals. The current supply circuits connect the capacitive elements to the output terminals such that each of the capacitive elements supplies power of a same polarity to the output terminals. The current supply circuits include plural switching elements, which selectively connect the capacitive elements to the output terminals. The control circuit controls the switching elements such that the capacitive elements are sequentially switched over to be connected to the output terminals.

### BRIEF DESCRIPTION OF THE DRAWINGS

The above and other objects, features and advantages will become more apparent from the following detailed description made with reference to the accompanying drawings. In the drawings:

FIG. 1 is a circuit diagram showing a power supply system for a vehicle including a DC-DC converter device according to the first embodiment;

FIG. 2A to FIG. 2F are time charts showing signal waveforms developed at different points in the first embodiment;

FIG. 3A to FIG. 3F are time charts showing waveforms developed at different points in the second embodiment;

FIG. 4 is a circuit diagram showing a power supply system for a vehicle including a DC-DC converter device according to the third embodiment;

FIG. 5 is a circuit diagram showing a power supply system for a vehicle including a DC-DC converter device according to the fourth embodiment;

FIG. 6 is a circuit diagram showing an operation state of the fourth embodiment;

FIG. 7 is a circuit diagram showing an operation state of the fourth embodiment;

FIG. 8 is a circuit diagram showing an operation state of the fourth embodiment;

FIG. 9A to FIG. 9E are time charts showing signal waveforms developed at different points in the fourth embodiment;

FIG. 10 is a circuit diagram showing a power supply system for a vehicle including a DC-DC converter device according to the fifth embodiment;

FIG. 11 is a circuit diagram showing a power supply system for a vehicle including a DC-DC converter device according to the sixth embodiment;

FIG. 12 is a circuit diagram showing a power supply system for a vehicle including a DC-DC converter device according to a comparative example; and

FIG. 13 is a time chart showing a drive signal for a switching element Q in the comparative example.

### DETAILED DESCRIPTION OF THE EMBODIMENT

A DC-DC converter device will be described in detail with reference to plural embodiments shown in the accompanying drawings, in which the same or similar parts are designated by the same or similar reference numerals to simplify the description.

### First Embodiment

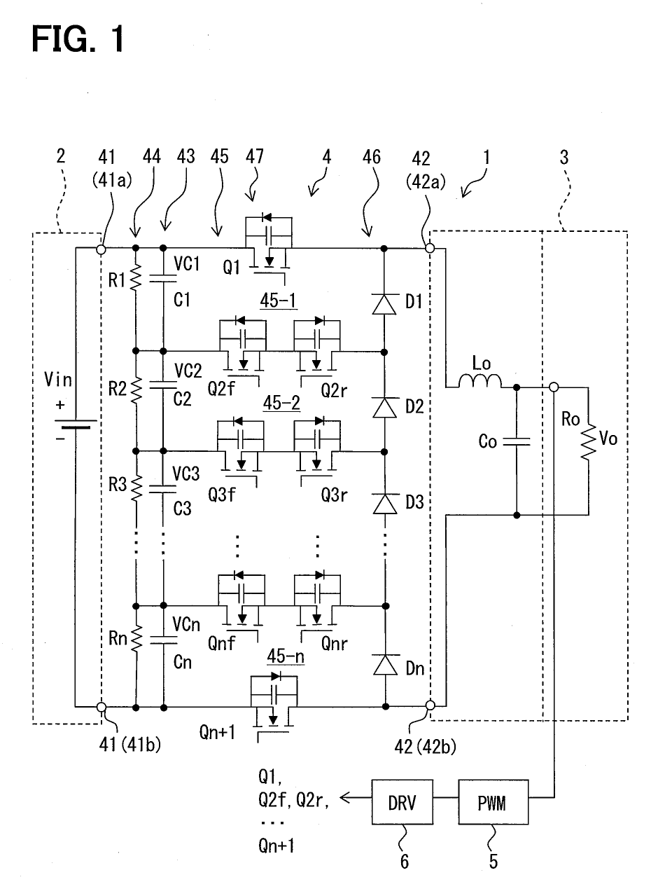

A DC-DC converter device is provided as a power supply system 1 for a vehicle according to the first embodiment shown in FIG. 1.

The power supply system 1 includes a converter circuit 4, which steps down a DC power supplied from a power source 2 to its input terminals 41 and supplies a DC power from its output terminals 42 to a load 3. The power source 2 is a DC battery mounted in the vehicle. The battery has a high voltage, which is supplied to a motor for vehicle travel. The battery supplies the DC power of several hundreds of volts. The battery outputs a power source voltage Vin. The power source voltage Vin is inputted as an input voltage to the input terminals 41 of the DC-DC converter circuit 4. The load 3 is connected to the output terminals 42 of the DC-DC converter circuit 4. The load 3 includes exemplarily a load element Ro as well as filter circuit, which is formed of a reactor Lo and a capacitor Co. The reactor Lo and the capacitor Co smooth the DC power supplied from the output terminals 42 to the load 3.

The DC-DC converter device may be defined to be the DC-DC converter circuit 4 only or the DC-DC converter circuit 4 with the filter circuit of the reactor Lo and the capacitor Co. The DC-DC converter circuit 4 includes a voltage divider circuit for dividing the power source voltage Vin and a chopper circuit for supplying divided voltages sequentially to the output terminals 42. The DC-DC converter circuit 4, the reactor Lo and the capacitor Co form a voltage step-down type converter device. The DC-DC converter circuit 4 includes a multi-stage voltage divider circuit having the first stage to the n-th stage.

The DC-DC converter circuit 4 is thus formed of a voltage dividing stage and a switching stage. The voltage dividing stage includes a voltage divider circuit, which divides the power source voltage Vin supplied to the input terminals 41. The voltage divider circuit is connected in series between the input terminals 41 and includes plural (first to n-th) capacitor elements C1 to Cn for dividing the voltage Vin supplied to the input terminals 41. The capacitive elements C1 to Cn are capacitors. The voltage divider circuit includes a capacitive divider circuit 43 and a resistive divider circuit 44. The capacitive divider circuit 43 includes the capacitive elements C1 to Cn connected in series between the input terminals 41. The resistive divider circuit 44 is connected between the input terminals 41 and includes plural (first to n-th) resistive elements R1 to Rn, which are connected to the capacitive elements C1 to Cn in parallel, respectively. The resistive elements R1 to Rn are resistors.

The resistive divider circuit 44 operates to balance divided voltages VC1 to VCn of the capacitive elements C1 to Cn in the DC-DC converter circuit 4. The resistive elements R1 to Rn equalize charge voltages of the capacitive elements C1 to Cn one another, which otherwise differ one another due to differences among capacitances and leak currents of the capacitive elements C1 to Cn. The resistance R is defined as R=Vin.(Vr−Vn/n)/C, in which the capacitance of the capacitive elements C1 to Cn is assumed to be C, the resistance of the resistive elements R1 to Rn is assumed to be R and a maximum surge voltage of the capacitive elements C1 to Cn is assumed to be Vr.

The switching stage includes plural current supply circuits 45 connected between the voltage divider circuit 44 and the output terminals 42. The current supply circuits 45 are referred to a current supply circuit network 45. The current supply circuits 45 connect the capacitive elements C1 to Cn to the output terminals 42. For example, the current supply circuits 45 are formed of a first current supply circuit 45-1 connecting the capacitive element C1 to the output terminals 42, a second current supply circuit 45-2 connecting the capacitive element C2 to the output terminals 42 and a n-th current supply circuit 45-n connecting the capacitive element Cn to the output terminals 42. Thus the same number of current supply circuits 45 as the capacitive elements C1 to Cn are provided to correspond each other. The current supply circuits 45 connect the capacitive elements C1 to Cn to the output terminals 42 so that each of the capacitive elements C1 to Cn supply the power of the same polarity to the output terminals 42. That is, the current supply circuit 45-1 connects the positive pole of the capacitive element C1 to a positive pole 42a of the output terminals 42 and the negative pole of the capacitive element C1 to a negative pole 42b of the output terminals 42. The current supply circuit 45-2 connects the positive pole of the capacitive element C2 to the positive pole 42a of the output terminals 42 and the negative pole of the capacitive element C2 to the negative pole 42b of the output terminals 42. The current supply circuit 45-n connects the positive pole of the capacitive element Cn to the positive pole 42a of the output terminals 42 and the negative pole of the capacitive element C1 to the negative pole 42b of the output terminals 42.

The switching stage includes plural switching elements Q1 to Qn+1, and D1 to Dn. Among the switching elements Q1 to Qn+1, each of the second to the n-th switching elements is formed of a pair of switching elements, which are on the positive side and the negative side and indicated as Q2f, Q2r and Qnf, Qnr, for example. The switching elements Q1 to Qn+1 and D1 to Dn are connected in the current supply circuits 45. The switching elements Q1 to Qn+1 and D1 to Dn operate to selectively render one of the current supply circuits 45 conductive.

The switching elements Q1 to Qn+1 are plural parallel switching elements Q1 to Qn+1. The switching elements D1 to Dn are plural series switching elements D1 to Dn.

The series switching elements D1 to Dn are connected in series between the output terminals 42. The switching elements D1 to Dn are provided in correspondence to the capacitive elements C1 to Cn, respectively. Each of the series switching elements D1 to Dn is a diode, which is a passive switching element. The diodes D1 to Dn are connected in series between the output terminals 42 and reverse-biased relative to the power source 2. Each of the series switching elements D1 to Dn allows current supply from the positive pole of the selected capacitive element to the positive pole 42a of the output terminals 42 and current supply from the negative pole 42b of the output terminals 42 to the negative pole of the selected capacitive element. Each of series switching elements D1 to Dn prevents a short-circuit between the positive pole and the negative pole of the selected capacitive element.

The parallel switching elements Q1 to Qn+1 are provided in current paths, which connect the capacitive elements C1 to Cn to the series switching elements D1 to Dn. The parallel switching elements Q1 to Qn+1 correlate the capacitive elements C1 to Cn to the series switching elements D1 to Dn in one-to-one relation. The parallel switching elements Q1 to Qn+1 are provided in lateral link parts of a ladder circuit, which includes the capacitive elements C1 to Cn and the series switching elements D1 to Dn. Each of the parallel switching elements. Q1 to Qn+1 is formed of a MOS-FET, which is an active switching element. The parallel switching elements Q1 to Qn+1 selects one of the capacitive elements C1 to Cn. The parallel switching elements Q1 to Qn+1 include positive-side switching elements Q1 to Qnf and negative-side switching elements Qnr to Qn+1. The positive-side switching elements Q1 to Qnf turn on and off current supply from the positive poles of the capacitive elements C1 to Cn to the positive pole 42a of the output terminals 42. The negative-side switching elements Qnr to Qn+1 turn on and off current supply from the negative poles 42b of the output terminals 42 to the negative poles of the capacitive elements C1 to Cn.

The parallel switching element Q1 is provided in the current path, which connects the positive pole of the capacitive element C1 and the cathode of the series switching element D1. The parallel switching element Q1 is a positive side switching element Q1, which turns on and off the current supply from the positive pole of the capacitive element C1 to the positive pole 42a of the output terminals 42. The parallel switching elements Q2f and Q2r are provided in the path, which connects the negative pole of the capacitive element C1 and the anode of the series switching element D1. The parallel switching element Q2 is a negative side switching element Q2r, which turns on and off the current supply from the negative pole 42b of the output terminals 42 to the negative pole of the capacitive element C1. The parallel switching element Q2f and the parallel switching element Q2r form a switching element Q2 for turning on and off the current supply in both directions.

The parallel switching elements Q2f and Q2r are provided in the path, which connects the positive pole of the capacitive element C2 and the cathode of the series switching element D2. The parallel switching element Q2f is a positive side switching element Q2f, which turns on and off the current supply from the positive pole of the capacitive element C2 to the positive pole 42a of the output terminals 42. The parallel switching elements Q3f and Q3r are provided in the path, which connects the negative pole of the capacitive element C2 and the anode of the series switching element D2. The parallel switching element Q3r is a negative side switching element Q3r, which turns on and off the current supply from the negative pole 42b of the output terminals 42 to the negative pole of the capacitive element C3. The parallel switching element Q3f and the parallel switching element Q3r form a switching element Q3 for turning on and off the current supply in both directions.

The parallel switching elements Qnf and Qnr are provided in the current path, which connects the positive pole of the capacitive element Cn and the cathode of the series switching element Dn. The parallel switching element Qnf is a positive side switching element Qnf, which turns on and off the current supply from the positive pole of the capacitive element Cn to the positive pole 42a of the output terminals 42. The parallel switching element Qnf and the parallel switching element Qnr form the switching element Qn for turning on and off the current supply in both directions. The parallel switching element Qn+1 is provided in the path, which connects the negative pole of the capacitive element Cn and the anode of the series switching element Dn. The parallel switching element Qn+1 is a negative side switching element Qn+1, which turns on and off the current supply from the negative pole 42b of the output terminals 42 to the negative pole of the capacitive element Cn.

The positive side switching element Q1 provided between the positive pole 41a of the input terminals 41 and the positive pole 42a of the output terminals 42 turns on and off the current supply from the positive pole 41a to the negative pole 42b. The negative side switching element Qn provided between the negative pole 42b of the output terminals 42 and the negative pole 41b of the input terminals 41 turns on and off the current supply from the negative pole 42a to the positive pole 41a. An intermediate potential point or a junction point between the series-connected two capacitive elements is referred to an intermediate point. The intermediate potential point or the junction point between the two series switching elements corresponding to the two capacitive elements is referred to the intermediate point. The positive side switching element and the negative side switching element, which are provided in the current path between these two corresponding intermediate points, form a switching element for turning on and off the current supply between the intermediate points. For example, the positive side switching element Q2f and the negative side switching element Qtr are provided between the intermediate point between the capacitive elements C1 and C2 and the intermediate point between the series switching elements D1 and d2.

The current supply circuits 45 include a series circuit section 46 and a parallel circuit section 47. The series circuit section 46 includes the series switching elements D1 to Dn. The parallel circuit section 47 includes the capacitive elements C1 to Cn and the series switching elements D1 to Dn connected in parallel to the capacitive elements C1 to Cn, respectively. The parallel circuit section 47 includes plural lateral link sections. The parallel switching elements Q1 to Qn+1 are provided in the lateral link sections, respectively.

The switching stage includes control circuits 5 and 6, which control the switching elements Q1 to Qn+1, D1 to Dn to sequentially switch over the capacitive elements C1 to Cn for connection to the output terminals 42. The control circuits 5 and 6 connect the capacitive elements C1 to Cn to the output terminals 42 in a predetermined order or sequence. Specifically, the control circuits 5 and 6 select only one capacitive element from the capacitive elements C1 to Cn in the predetermined order or sequence and connect only the selected capacitive element to the output terminals 42. The control circuit 5 is a PWM control circuit (PWM), which regulates duty ratios of the drive signals for the switching elements Q1 to Qn+1 so that the output voltage Vo attains a target voltage. The control circuit 6 is a driver circuit (DRV), which applies the drive signals, that is, gate-source voltages, for the switching elements Q1 to Qn+1 in accordance with instructions from the PWM control circuit 5.

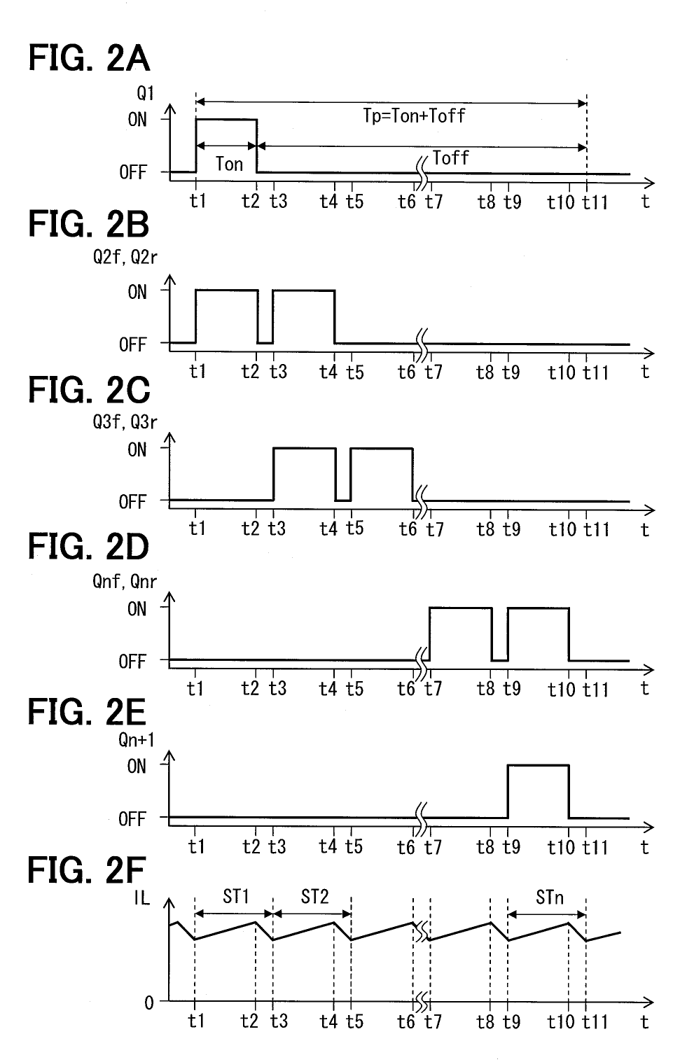

The control circuits 5 and 6 control the switching elements Q1 to Qn+1 as shown in FIG. 2A to FIG. 2F. FIG. 2A shows a drive signal for the switching element Q1. FIG. 2B shows drive signals for the switching elements Q2f and Qtr. FIG. 2C shows drive signals for the switching elements Q3f and Q3r. FIG. 2D shows drive signals for the switching elements Qnf and Qnr. FIG. 2E shows a drive signal for the switching element Qn+1. FIG. 2F shows a current IL of the reactor Lo. In these figures, the axis of abscissa indicates time t.

The drive signals for the switching elements Q1 to Qn+1 are specified by a cycle period Tp, an on-period Ton, and an off-period Toff. In the example shown, the switching element Q1 is in the on-state between time t1 and time t2. The switching elements Q2f and Q2r are in the on-state between time t1 and time t2 and between time t3 and time t4. The switching elements Q3f and Q3r are in the on-state between time t3 and time t4 and between time t5 and time t6. The switching elements Qnf and Qnr are in the on-state between time t7 and time t8 and between time t9 and time t10. The switching element Qn+1 is in the on-state between time t9 and time t10.

Between time t1 and time t2, the switching element Q1 and the switching element Q2 (Q2f, Q2r) provided in the first current supply circuit 45-1 are turned on and hence the capacitive element C1 is connected to the output terminals 42. Thus the voltage of the capacitive element C1 is supplied to the output terminals 42. As a result, the current IL, which flows in the reactor Lo, gradually increases. Between time t2 and time t3, all the switching elements are turned off and hence none of the capacitive elements C1 to Cn is connected to the output terminals 42. In this period, the series switching element D1 to Dn operate as free-wheeling diodes and provide a free-wheeling circuit. Thus the current IL gradually decreases by the energy stored in the reactor Lo. The period between time t1 and time t3 is referred to as the first stage ST1. In this first stage ST1, the energy stored in the capacitive element C1 is supplied to the load 3 as the DC power.

Between time t3 and time t4, the switching element Q2 (Q2f, Q2r) and the switching element Q3 (Q3f, Q3r) provided in the second current supply circuit 45-2 are turned on and hence the capacitive element C2 is connected to the output terminals 42. Thus the voltage of the capacitive element C2 is supplied to the output terminals 42. As a result, the current IL, which flows in the reactor Lo, gradually increases. Between time t4 and time t5, all the switching elements are turned off and hence none of the capacitive elements C1 to Cn is connected to the output terminals 42. In this period, the series switching elements D1 to Dn operate as free-wheeling diodes and provide a free-wheeling circuit. Thus the current IL gradually decreases by the energy stored in the reactor Lo. The period between time t3 and time t5 is referred to as the second stage ST1. In this second stage ST2, the energy stored in the capacitive element C2 is supplied to the load 3 as the DC power.

Then the similar operations are repeated with respect to each of the capacitive elements C3, C4 to Cn in sequence. In the last stage of one cycle period, that is, between time t9 and time t10, the switching element Qn (Qnf, Qnr) and the switching element Qn+1 provided in the n-th current supply circuit 45-n are turned on and hence the capacitive element Cn is connected to the output terminals 42. Thus the voltage of the capacitive element Cn is supplied to the output terminals 42. As a result, the current IL, which flows in the reactor Lo, gradually increases. Between time t10 and time t11, all the switching elements are turned off and hence none of the capacitive elements C1 to Cn is connected to the output terminals 42. In this period, the series switching elements D1 to Dn operate as free-wheeling diodes and provide a free-wheeling circuit. Thus the current IL gradually decreases by the energy stored in the reactor Lo. The period between time t9 and time t11 is referred to as the n-th stage STn. In this n-th stage STn, the energy stored in the capacitive element Cn is supplied to the load 3 as the DC power.

According to the first embodiment, the power source voltage Vin is divided into 1/n by the capacitive divider circuit 43. The divided voltages are supplied to the output terminals 42 sequentially, that is, one by one, in the same polarity. Since the switching elements Q1 to Qn+1 are duty-controlled, the divided voltages are further stepped down. As a result, the output voltage Vo of a low amplitude is supplied by stepping down the power source voltage Vin of a high amplitude. Since the capacitive divider circuit 43 is provided, the circuits can be configured by elements, which do not withstand high voltages.

### Second Embodiment

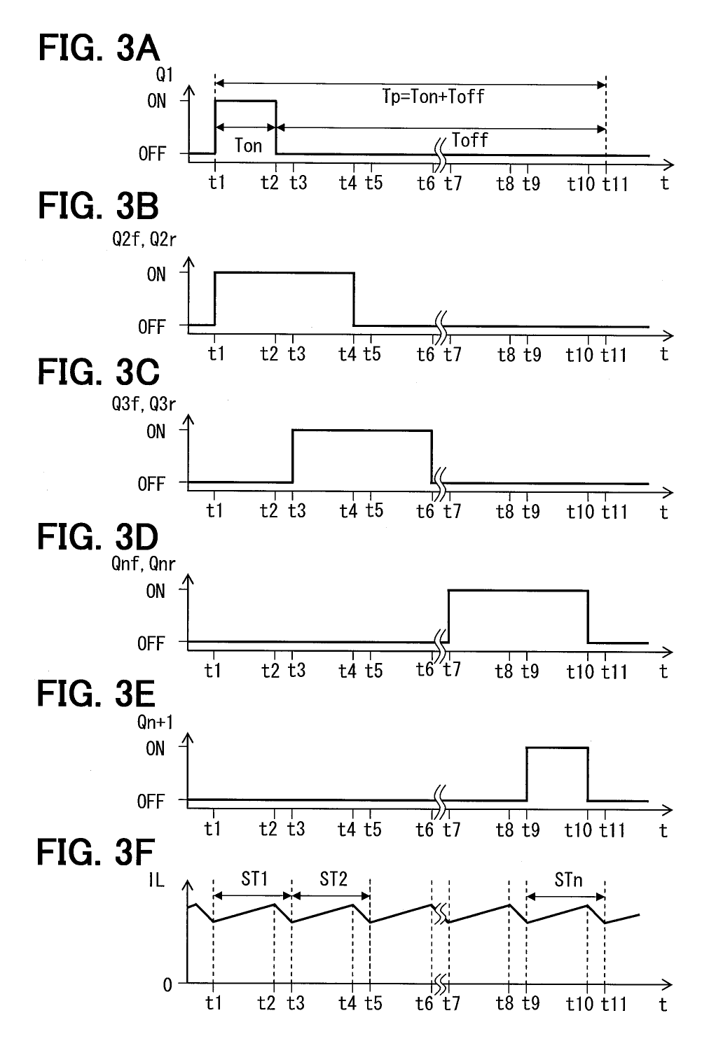

In the second embodiment, the switching elements Q1 to Qn+1 are driven in accordance with a sequence shown in FIG. 3A to FIG. 3E. FIG. 3A shows a drive signal for the switching element Q1. FIG. 3B shows drive signals for the switching elements Q2f and Q2r. FIG. 3C shows drive signals for the switching elements Q3f and Q3r. FIG. 3D shows drive signals for the switching elements Qnf and Qnr. FIG. 3E shows a drive signal for the switching element Qn+1. FIG. 3F shows a current IL of the reactor Lo.

In the first embodiment, the switching elements, for example, Qnf and Qnr, which connect the intermediate point of the capacitive divider circuit 43 and the intermediate point of the series circuit 46, are in the on-state only in the current supply period to the reactor Lo. According to the second embodiment, however, the control circuits 5 and 6 output the drive signals so that the switching elements, for example, Qnf and Qnr, connecting the intermediate point of the capacitive divider circuit 43 and the intermediate point of the series circuit 46 maintain the on-state for a period, which is twice as long as the period of current supply to the reactor Lo.

In the second embodiment, the switching element Q2 (Q2f, Q2r) is turned on between time t1 and time t4. The switching elements Q3 (Q3f, Q3r) is turned on between time t3 and time t6. The switching element Qn (Qnf, Qnr) is turned on between time t7 and time t10. The current IL thus increases and decreases similarly to the first embodiment and the similar advantage as the first embodiment is provided. In addition, the number of times of switching the switching elements is decreased.

### Third Embodiment

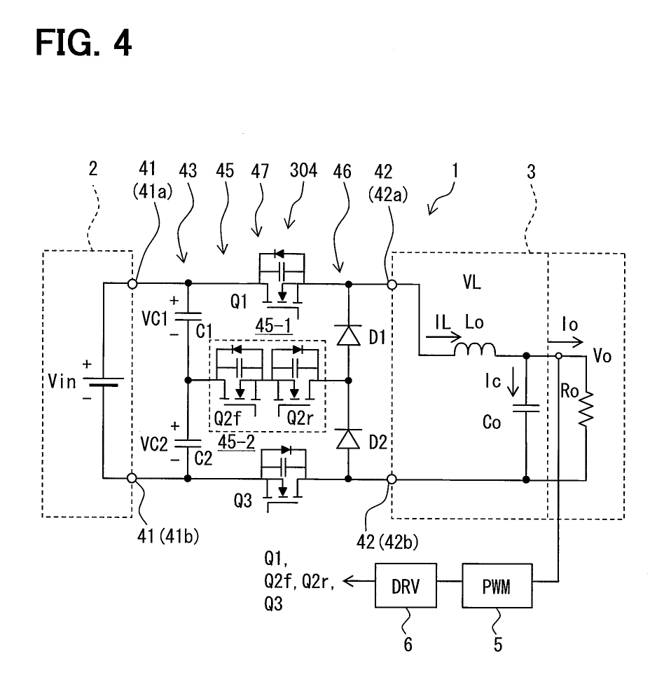

In the first and the second embodiments, the DC-DC converter circuit 4 has plural (n) stages. Alternatively, in the third embodiment, a DC-DC converter circuit 304 is simplified to have only two stages as shown in FIG. 4.

Specifically, a voltage divider circuit includes only the capacitive divider circuit 43. The capacitive divider circuit 43 includes the first capacitive element C1 and the second capacitive element C2. The series circuit section 46 includes the first series switching element D1 and the second series switching element D2. The parallel circuit section 47 includes the parallel switching elements Q1, Q2 (Q2f, Q2r) and Q3. The first parallel switching element Q1 turns on and off the current supply from the positive pole of the first capacitive element C1 to the positive pole 42a of the output terminals 42. According to this configuration, one intermediate point is between the first capacitive element C1 and the second capacitive element C2 and the other intermediate point is between the first series switching element D1 and the second series switching element D2. The second parallel switching element Q2 (Q2f and Q2r) turns on and off the current supply between the intermediate point of the capacitive divider circuit 43 and the intermediate point of the series circuit section 46. The parallel third switching element Q3 turns on and off the current supply from the negative pole 42b of the output terminals 42 to the negative pole of the second capacitive element C2. According to this configuration, the first current supply circuit 45-1 connecting the first capacitive element C1 and the output terminals 42 and the second current supply circuit 45-2 connecting the second capacitive element C2 and the output terminals 42 are provided. The third embodiment also provides the similar operation and advantages as the first and the second embodiment.

### Fourth Embodiment

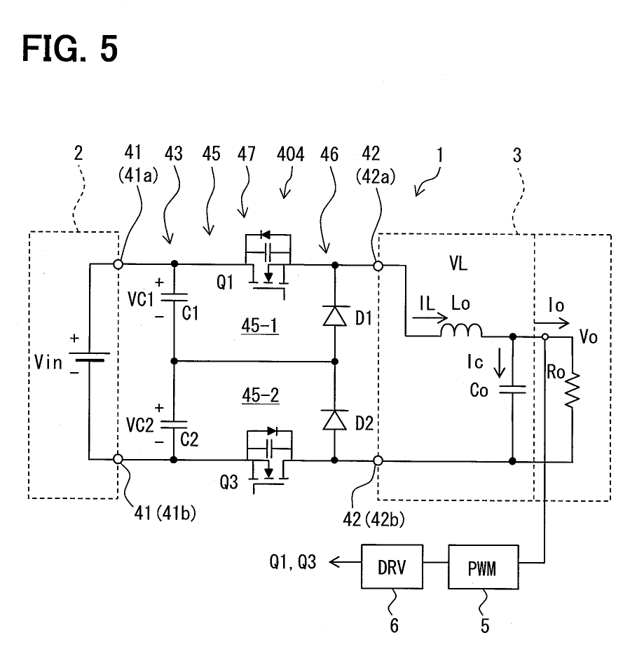

In the first to the third embodiments, the switching elements are provided between the intermediate point of the capacitive divider circuit 43 and the intermediate point of the series circuit section 46. Alternatively, in the fourth embodiment, a converter circuit 404 is configured such that the intermediate points are directly connected as shown in FIG. 5.

In the fifth embodiment, the parallel circuit section 47 includes the parallel switching elements Q1 and Q3. The first parallel switching element Q1 turns on and off the current supply from the positive pole of the first capacitive element C1 to the positive pole 42a of the output terminals 42. The second parallel switching element Q3 turns on and off the current supply from the negative pole 42b of the output terminals 42 to the negative pole of the second capacitive element C2. No switching element is provided in a current path, which connects one intermediate point between the first capacitive element C1 and the second capacitive element C2 and the other intermediate point between the first series switching element D1 and the second series switching element D2. According to this configuration, the first current supply circuit 45-1 connecting the first capacitive element C1 and the output terminals 42 and the second current supply circuit 45-2 connecting the second capacitive element C2 and the output terminals 42 are provided.

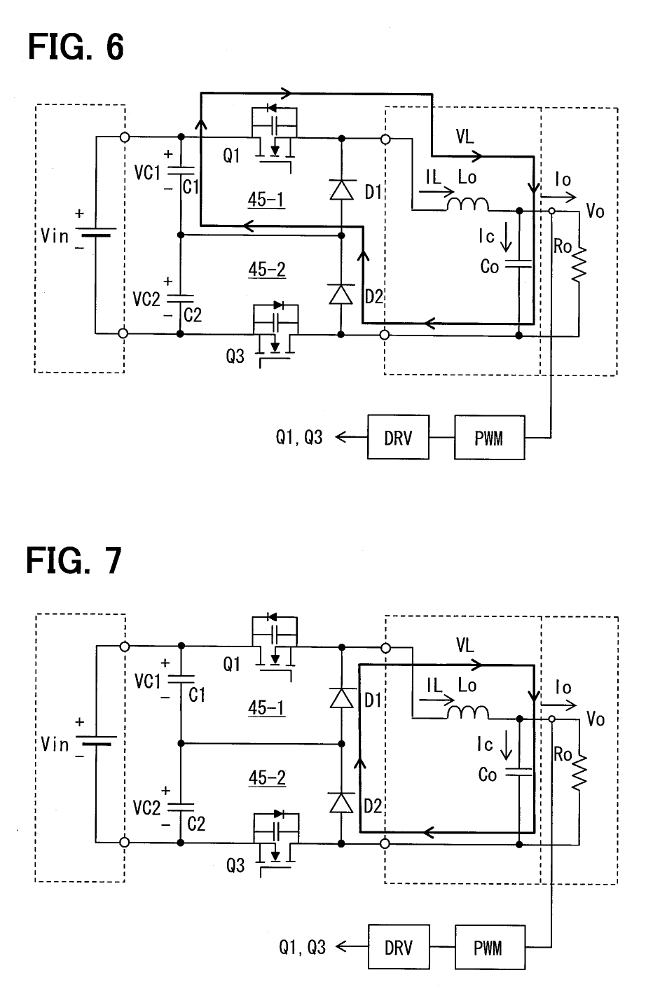

When the parallel switching element Q1 is turned on, the current supply circuit 45-1 is closed. In this state, the first capacitive element C1 supplies the power to the output terminals 42. As a result, the current IL flows in a path indicated by an arrow in FIG. 6.

When the parallel switching elements Q1 and Q3 are turned off, the current supply circuits 45-1 and 45-2 are opened. In this state, the series circuit section 46 provides a circuit for supplying the current IL based on energy stored in the reactor Lo. The series switching elements D1 and D2 operate as the free-wheeling elements as shown in FIG. 7.

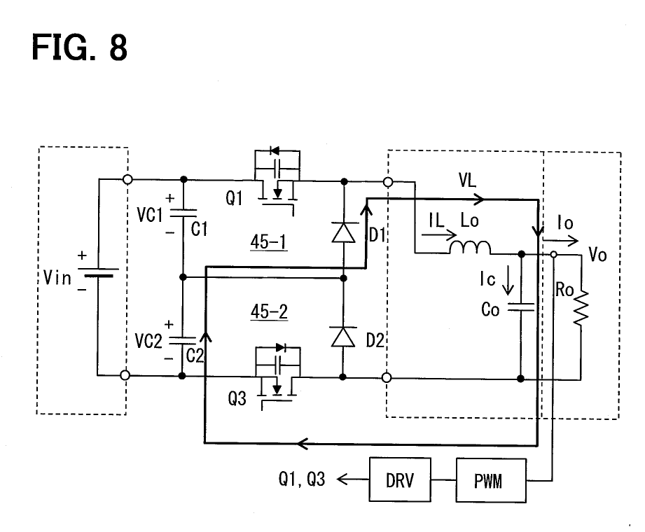

When the parallel switching element Q3 is turned on, the current supply circuit 45-2 is closed. In this state, the second capacitive element C2 supplies power to the output terminals 42. As are result, the current IL flows in a current path indicated by an arrow in FIG. 8.

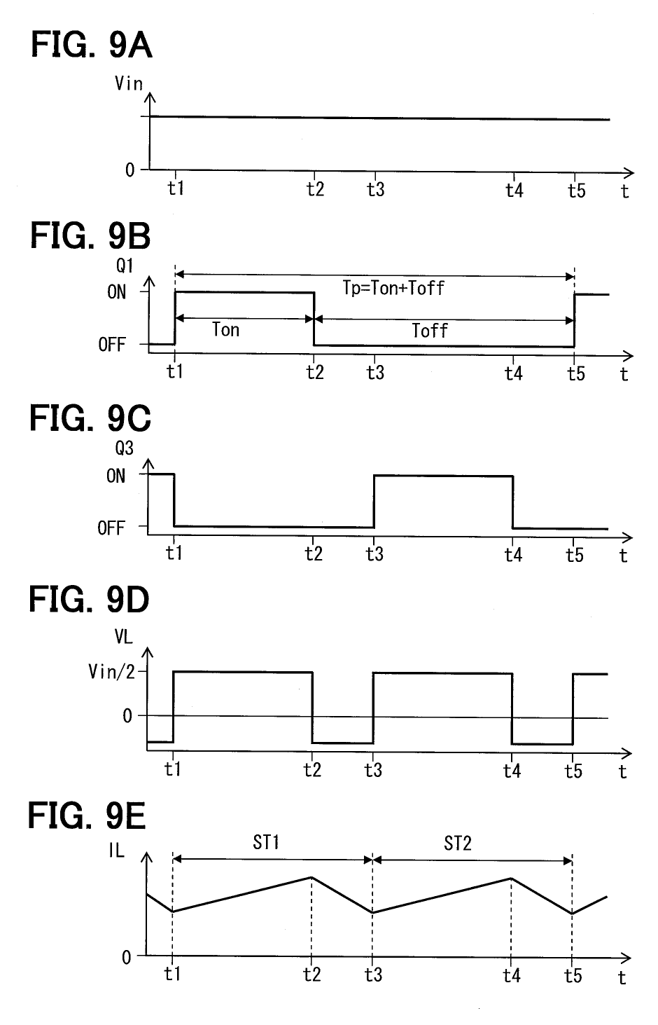

The fourth embodiments operates as shown in FIG. 9A to FIG. 9E. FIG. 9A shows the power source voltage Vin. FIG. 9B shows the drive signal for the parallel switching element Q1. FIG. 9C shows the drive signal for the parallel switching element Q3. FIG. 9D shows the terminal voltage VL of the reactor Lo. FIG. 9E shows the current IL of the reactor Lo.

In the fourth embodiment, the parallel switching element Q1 is in the on-state between time t1 and time t2. The parallel switching element Q1 is in the off-state between time t2 and time t5. The parallel switching element Q3 is in the on-state between time t3 and time t4. The parallel switching element Q3 is in the off-state between time t1 and time t3. Since the parallel switching elements Q1 and Q3 thus turn on and off, the voltage VL developed across the reactor Lo and the current IL flowing in the reactor Lo change as shown in FIG. 9D and FIG. 9E, respectively.

In the fourth embodiment as well, the similar operation and advantage as the first embodiment are provided. In addition, the number of the parallel switching elements is decreased.

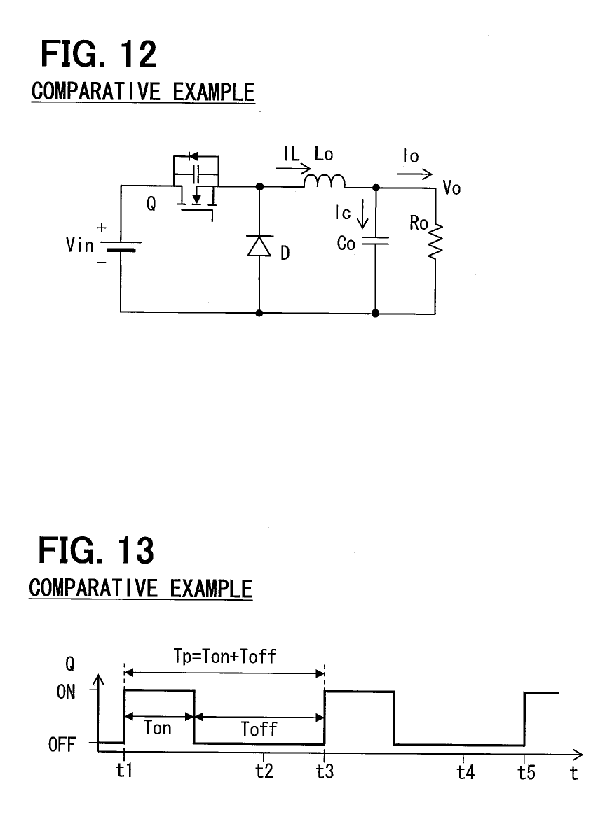

Here, the fourth embodiment is compared with a DC-DC converter device according to a comparative example shown in FIG. 12 and FIG. 13. In FIG. 13, the axis of abscissa is in the same scale as in FIG. 9.

This comparative example is also a step-down type DC-DC converter circuit of a single stage having no voltage divider circuit. This DC-DC converter circuit steps down the power source voltage Vin to the output voltage Vo and supplies the current Io to the load element Ro. The duty ratio D(C) for stepping down the power source voltage Vin to the output voltage Vo is defined as D(C)=Vo/Vin. The switching loss Ploss(C) in one switching element Q is defined as Ploss(C)={Vin·Io·(tr+tf)·fs}/2. Here, (tr+tf) is a switching period in each second, tr is a rise time of the current flowing to the switching element, tf is a fall time of the current flowing in the switching element, fs is a switching frequency (Hz) and fs is defined as fs=1/Tp.

In the fourth embodiment shown in FIG. 5, the power source voltage Vin is divided by the capacitive divider circuit 43. The voltage of the two capacitive elements C1 and C2 connected in series is defined as VC1=Vin/2 and VC2 is defined as VC2=Vin/2. The duty ratio D(P) for stepping down the current supply voltage Vin to the output voltage Vo is defined as D(P)=Vo/VC1=Vo/VC2=Vo/(Vin/2). If compared with the comparative example, the following relation holds, that is, D(P)=2·D(C). Thus, the duty ratios of the switching elements Q1 and Q3 become twice as large as that of the comparative example. As a result, it is possible to avoid that the on-periods of the switching elements Q1 and Q2 become excessively short.

According to the fourth embodiment, since the parallel switching elements Q1 and Q3 are turned on alternately, the drive frequency of one switching element Q1 is fs/2. The switching loss Ploss(P) of one switching element Q1 is defined as Ploss(P)=(Vin/2)·Io·(tr+tf)·(fs/2)/2. The two parallel switching elements Q1 and Q3 perform switching operations. The total switching loss Ploss(P2) of the two parallel switching elements Q1 and Q3 is defined as Ploss(P2)=(Vin/2)·Io·(tr+tf)·(fs/2). If compared with the comparative example, the loss of the fourth embodiment is halved as Ploss(P2) =Ploss(C)/2. Thus, the DC-DC converter device has a high efficiency by suppression of the switching loss.

### Fifth Embodiment

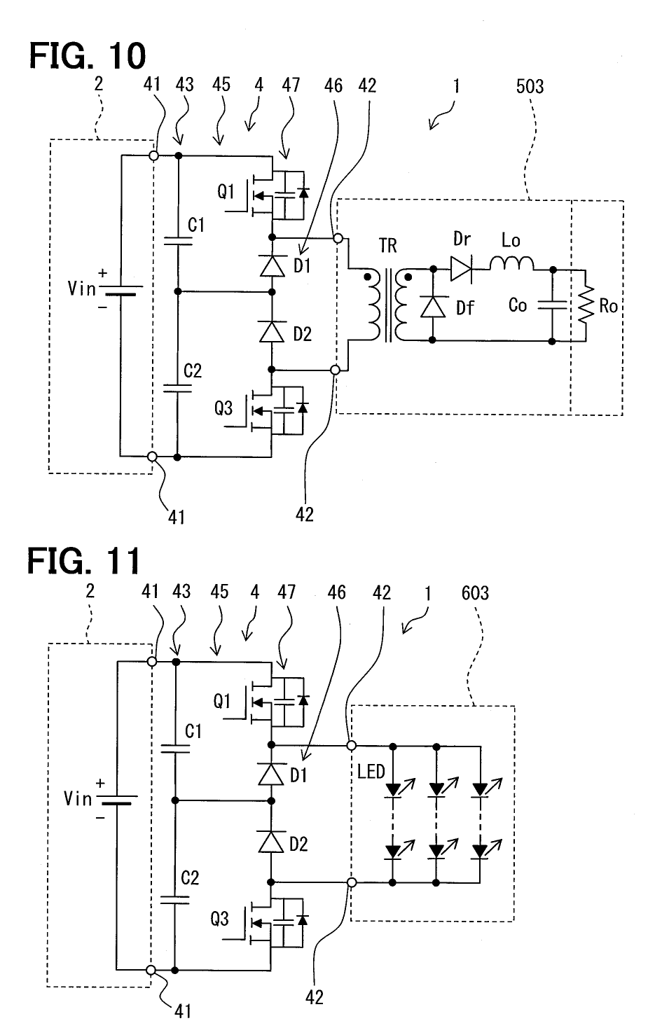

In the first to the fourth embodiments, the DC-DC converter circuit 4 is formed as a non-insulating type DC-DC converter device. Alternatively, it is possible to supply the output of the DC-DC converter circuit 4 to different loads. For example, the DC-DC converter circuit 4 may be configured as an insulating type DC-DC converter device as shown in FIG. 10.

In the fifth embodiment, a load 503 includes circuit elements, which form an insulating type DC-DC converter device. The load 503 includes an insulating transformer TR connected to the output terminals 42 and the rectifiers Dr for rectifying an output of the insulating transformer TR. The output terminals 42 are connected to a primary coil of the insulating transformer TR. The rectifier Dr is a diode. In the load 503, a free-wheeling diode Df is connected in parallel to a secondary coil of the insulating transformer TR. The diode Df is reverse-biased. The load 503 includes the reactor Lo, the capacitor Co and the load element Ro. The insulating type DC-DC converter device is formed by the DC-DC converter circuit 4, the insulating transformer TR, the free-wheeling diode Df, the rectifying diode Dr, the reactor Lo and the capacitor Co.

### Sixth Embodiment

In the first to the fifth embodiments, the filter circuit including the reactor Lo and the capacitor Co is provided at the rear stage of the DC-DC converter circuit 4. However, the output of the DC-DC converter circuit 4 may be supplied directly to the DC load as shown in FIG. 11.

A load 603 is a LED array including plural light-emitting diodes. This LED array may be used in various illumination devices mounted in a vehicle. For example, it may be used in a front light, a tail light, a turn indicator light, a compartment interior light, a meter display light, a backlight for a liquid crystal display and the like.

### Other Embodiments

The above-described embodiments are only exemplary and may be modified as other embodiments.

For example, in place of forming one capacitive element by one capacitor, one capacitive element may be formed of plural capacitors.

In the third and the fourth embodiments, the resistive divider circuit 44 may be added to the capacitive divider circuit 43 as in the first and the second embodiments.

The control circuits 5 and 6 may be implemented by a programmed computer, a hard-wired circuit or a combination of both.

What is claimed is:

1. A DC-DC converter device for stepping down a DC power supplied to input terminals and supplying a stepped-down DC power to output terminals, the DC-DC converter device comprising:
a voltage divider circuit connected between the input terminals in series and including plural capacitive elements for dividing an input voltage supplied to the input terminals;
plural current supply circuits provided between the voltage divider circuit and the output terminals and connecting the capacitive elements to the output terminals such that each of the capacitive elements supplies power of a same polarity to the output terminals, the current supply circuits including plural switching elements, which selectively connect the capacitive elements to the output terminals; and
a control circuit for controlling the switching elements such that the capacitive elements are sequentially switched over to be connected to the output terminals.

2. The DC-DC converter device according to claim 1, wherein the switching elements include:
plural series switching elements connected in series between the output terminals; and
plural parallel switching elements provided in current paths connecting the capacitive elements and the series switching elements in parallel.

3. The DC-DC converter device according to claim 2, wherein:
the series switching elements include plural diodes connected in series in an opposite polarity between the output terminals.

4. The DC-DC converter device according to claim 3, wherein the parallel switching elements include:
a positive side switching element for turning on and off current supply from a positive pole of the capacitive elements to a positive pole of the output terminals; and
a negative side switching element for turning on and off current supply from a negative pole of the output terminals to a negative pole of the capacitive element.

5. The DC-DC converter device according to claim 3, wherein:
the voltage divider circuit includes a first capacitive element and a second capacitive element;
the series switching elements include first series switching element and a second series switching element;
the parallel switching elements include a first parallel switching element, which turns on and off current supply from a positive pole of the first capacitive element to the positive side of the output terminals, and a second parallel switching element, which turns on and off current supply from the negative pole of the output terminals to a negative pole of the second capacitive element;
the current supply circuits are provided by connection of an intermediate point between the first capacitive element and the second capacitive element and an intermediate point between the first series switching element and the second series switching element; and
the current supply circuits include a first current supply circuit, which connects the first capacitive element and the output terminals, and a second current supply circuit, which connects the second capacitive element and the output terminals.

6. The DC-DC converter device according to claim 1, wherein the voltage divider circuit includes:
a capacitive divider circuit including plural capacitive elements connected in series between the input terminals; and
a resistive divider circuit including plural resistive elements connected in series between the input terminals and in parallel to the capacitive elements, respectively.

7. The DC-DC converter device according to claim 1, further comprising:
a reactor and a capacitor, which are connected to the output terminals to smooth the DC power supplied to the output terminals.

8. The DC-DC converter device according to claim 1, further comprising:
an insulating transformer connected to the output terminals and a rectifier for rectifying an output of the insulating transformer.

9. The DC-DC converter device according to claim 1, further comprising:
a DC load connected to the output terminals.
